(19) United States
(12) Patent Application Publication
(10) Pub. No.: US 2022/0244200 A1
(43) Pub. Date: Aug. 4, 2022

(54) SYSTEMS AND METHODS FOR PROCESSING MATERIALS WITH COMPLEX ISOTOPE VECTORS FOR USE AS A NUCLEAR FUEL

(71) Applicant: Westinghouse Electric Company LLC, Cranberry Township, PA (US)

(72) Inventor: David L. STUCKER, Chapin, SC (US)

(73) Assignee: Westinghouse Electric Company LLC, Cranberry Township, PA (US)

(21) Appl. No.: 17/165,726

(22) Filed: Feb. 2, 2021

(51) Int. Cl. G01N 23/22; G01N 23/221

(52) U.S. Cl. CPC G01N 23/22; G01N 2223/00; G01N 23/221

(57) ABSTRACT

A method of processing a nuclear material for use as a nuclear fuel in a nuclear reactor is disclosed herein. The nuclear material includes a complex isotope vector including a plurality of isotopes including a targeted isotope and a non-targeted isotope. The method can include: determining a wavelength of electromagnetic radiation based, at least in part, on the targeted isotope; emitting a beam of electromagnetic radiation including the determined wavelength towards the nuclear material; separating, via the emitted beam of electromagnetic radiation, the nuclear material into a first stream and a second stream; enriching, via the emitted beam of electromagnetic radiation, a concentration of the targeted isotope to a predetermined concentration; and dispositioning, via a sensitivity to the determined wavelength, the enriched concentration of the targeted isotope to the first stream of the nuclear material; and dispositioning, via a lack of sensitivity to the determined wavelength, the non-targeted isotope to the second stream of the nuclear material.

### FIELD

The present disclosure is generally related to nuclear power generation and, more particularly, is directed to improved systems and methods for processing of used nuclear fuel, which includes the enrichment of desirable isotopes and scrubbing (depleting) of undesirable isotopes.

### SUMMARY

The following summary is provided to facilitate an understanding of some of the innovative features unique to the aspects disclosed herein and is not intended to be a full description. A full appreciation of the various aspects can be gained by taking the entire specification, claims, and abstract as a whole.

In various aspects, a method of processing a nuclear material for use as a nuclear fuel in a nuclear reactor is disclosed. The nuclear material can include a complex isotope vector including a plurality of isotopes including a targeted isotope and a non-targeted isotope. The method can include: determining a wavelength of electromagnetic radiation based, at least in part, on the targeted isotope; emitting a beam of electromagnetic radiation including the determined wavelength towards the nuclear material; separating, via the emitted beam of electromagnetic radiation, the nuclear material into a first stream and a second stream; enriching, via the emitted beam of electromagnetic radiation, a concentration of the targeted isotope to a predetermined concentration; and dispositioning, via a sensitivity to the determined wavelength, the enriched concentration of the targeted isotope to the first stream of the nuclear material; and dispositioning, via a lack of sensitivity to the determined wavelength, the non-targeted isotope to the second stream of the nuclear material.

In various aspects, a system configured to process a nuclear material for use as a nuclear fuel in a nuclear reactor is disclosed. The nuclear material comprises a complex isotope vector comprising a targeted isotope and a non-targeted isotope. The system can include: an emitter configured to emit a beam of electromagnetic radiation at the nuclear material; and a control circuit configured in signal communication with the emitter, wherein the control circuit is configured to: receive an input comprising a wavelength of electromagnetic radiation, wherein the wavelength is determined based, at least in part, on the targeted isotope; and cause the emitter to emit a beam comprising the wavelength of electromagnetic radiation towards the nuclear material; wherein the wavelength of electromagnetic radiation, upon interacting with the nuclear material, is configured to: separate the nuclear material into a first stream and a second stream; enrich a concentration of the targeted isotope to a predetermined concentration; disposition, via a sensitivity to the wavelength of electromagnetic radiation, the enriched concentration of the targeted isotope to the first stream of the nuclear material; and disposition, via a lack of sensitivity to the wavelength of electromagnetic radiation, the non-targeted isotope to the second stream of the nuclear material.

In various aspects, a method of processing a nuclear material for use as a nuclear fuel in a nuclear reactor is disclosed. The nuclear material can include a complex isotope vector can include a plurality of isotopes, wherein the plurality of isotopes can include a targeted isotope and a non-targeted isotope. The method can include: emitting a beam of electromagnetic radiation including a wavelength towards the nuclear material; enriching, via the beam of electromagnetic radiation, a concentration of the targeted isotope to a predetermined concentration; dispositioning, via a sensitivity to the wavelength, the enriched concentration of the targeted isotope to a first stream of the nuclear material; and dispositioning, via a lack of sensitivity to the wavelength, the non-targeted isotope to a second stream of the nuclear material.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a diagram of a system configured to process a nuclear material for use as a nuclear fuel in a nuclear reactor, in accordance with at least one non-limiting aspect of the present disclosure;

FIG. 2 illustrates a method of processing a nuclear material for use as a nuclear fuel in a nuclear reactor, in accordance with at least one non-limiting aspect of the present disclosure;

FIG. 3 illustrates a table contrasting the contents of a product stream and tail stream of a nuclear material processed via the system of FIG. 1 and the method of FIG. 2, in accordance with at least one non-limiting aspect of the present disclosure; and

FIG. 4 illustrates a table depicting some of the benefits of processing various nuclear materials via the system of FIG. 1 and the method of FIG. 2, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms. Furthermore, it is to be understood that such terms as “forward”, “rearward”, “left”, “right”, “upwardly”, “downwardly”, and the like are words of convenience and are not to be construed as limiting terms.

In the following description, like reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

Before explaining various aspects of the articulated manipulator in detail, it should be noted that the illustrative examples are not limited in application or use to the details of disclosed in the accompanying drawings and description. It shall be appreciated that the illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Specifically, it shall be appreciated that any discussion of a particular nuclear fuel (e.g., uranium) and its isotopes (e.g., ²³⁵U) are merely illustrative and can be applied to any our source of nuclear fuel (e.g., plutonium, thorium, neptunium, americium, curium and other fissionable members of the actinide group of elements) and its isotopes. As used herein, “minor actinides” shall be construed to include less common nuclear fuels, including any actinide other than those specifically referenced herein. Additionally, the nuclear fuels discussed herein can be implemented for reactors of varying designs, including, but not limited to, MAGNOX, CANDU, light-water reactor (LWR), advanced-gas cooled (AGR), high-powered channel-type reactor (RBMK), low-enriched uranium (LEU) fueled, and/or highly-enriched uranium (HEU)-fueled designs. The present disclosure is applicable for any nuclear materials including complex isotope vectors. Also, it shall be appreciated that one or more of the following-described aspects, expressions of aspects, and/or examples, can be combined with any one or more of the other following-described aspects, expressions of aspects, and/or examples.

Nuclear material consists of elements determined by the number of protons or “Z” number such as uranium (Z=92) and plutonium (Z=94). Elements are generally relatively easily separated by chemical means. An element (constant Z) is also made up of a collection of isotopes or range of “A” numbers result from a changing number of neutrons that give the approximate atomic mass such as 235 for uranium 235 (²³⁵U), the primary fissile isotope of uranium. In this example, the ²³⁵U isotope has 235 (“A” number)—92 (“Z” number)=143 neutrons while uranium 238 has 238-92=146 neutrons. For each element the assay of individual isotopes is indicative of the origin of the nuclear material and the combined time and neutron exposure within a reactor. In nature, uranium is found as uranium isotopes ²³⁸U (99.2739-99.2752%), ²³⁵U (0.7198-0.7202%), and ²³⁴U (0.0050-0.0059%). From a practical perspective, the natural uranium isotope vector is a binary difference of a heavy and a light isotope. This is contrasted by the reprocessed uranium isotope vector that typically contains measurable concentrations of uranium isotopes ²³²U, ²³³U, ²³⁴U, ²³⁵U, ²³⁶U and ²³⁸U.

The present disclosure is directed to systems and methods for processing nuclear materials for use as a nuclear fuel. As used herein, the term “processing” shall be construed to include, at a minimum, the enrichment of desirable isotopes and the removal of undesirable isotope within the used nuclear material.

Nuclear material can include a complex isotope vector including a plurality of even-numbered fertile isotopes and generally fewer odd-numbered isotope. The method includes determining the wavelength(s) of electromagnetic radiation based, at least in part, on the desired, generally odd numbered isotope based on higher probability of fission; emitting such a beam of electromagnetic radiation including the determined wavelength towards a stream of process feed nuclear material; separating the complex isotopomers via the emitted beam of electromagnetic radiation into one of two paths either product or tails. The product stream which is enriched in the targeted odd isotope via the emitted beam of electromagnetic radiation, a concentration of the odd-numbered isotope to a predetermined concentration, and the balance of the feed stream unaffected by the emitted beam of electromagnetic radiation being swept away into the tails (depleted) stream.

Conventional fuels (e.g. uranium, plutonium, thorium, amongst others) for nuclear reactors typically require a specific concentration of desirable isotopes (e.g., odd-numbered isotopes, such as ²³⁵U). It is generally understood that natural ores do not contain sufficient concentrations of desirable isotopes to be suitable for use as a nuclear fuel. For example, the concentration of ²³⁵U found in natural uranium ores can be relatively low (e.g., approximately 0.7%)—significantly less than what is required for use in most nuclear reactors (e.g., greater than or equal to 3% but less than or equal to 10%). Likewise, used nuclear materials—or natural ores that were initially processed and subsequently used as a nuclear fuel—no longer contain sufficient concentrations of desirable isotopes for reuse as a nuclear fuel. As such, both natural and used nuclear materials must be processed via methods of enrichment, wherein concentrations of the desirable isotopes are increased to a predetermined level in accordance with the intended application. In order to be used as a fuel in an LWR, for example, the concentrations must be sufficient to support the desired fission reaction, wherein the nuclei of the targeted isotope(s) fission and produce a combination of heat and enough neutrons to sustain the chain reaction. The heat can be harnessed to generate electricity and the neutrons can sustain and control the reaction.

Significant resources have been invested in developing systems and methods for enriching used nuclear materials. Although known methods—such as gaseous diffusion and centrifugal separation—are capable of increasing the concentration of desirable isotopes, they also increase the concentration of undesirable isotopes because the enrichment using these processes is based on the mass difference between the isotopomer. For example, in the case of uranium, separation due to mass difference has the effect of segregating U-238 to the tails stream and all of the other isotopes to the product stream. The undesirable isotopes infiltrate the product stream produced by such conventional methods which, in the case of uranium, results in high-radiation fields arising from the ²³²U decay products that necessitate expensive post-processing at separate fuel-fabrication facilities or products containing high ²³⁶U that results highly parasitic fuel requiring additional ²³⁵U enrichment to compensate for the parasitic nature of using fuel with high concentrations of ²³⁶U. Accordingly, it is widely acknowledged that enriching used nuclear materials such as recycled uranium is more expensive and less efficient than producing nuclear fuel from natural ores because the savings in avoiding the uranium ore purchase is insufficient to compensate for the higher cost of conversion, enrichment and fabrication that are required when the enrichment process is mass difference based as are all current art processes. The lack of a positive business case for returning the recycled material back into the fuel cycle has resulted in a surplus of used nuclear fuel because it is simply more expensive to recycle than it is to use freshly mined uranium.

These deficiencies are inherent to the aforementioned systems and methods, because they rely on mass difference-based means of enrichment. For example, centrifugal separation uses a working gas (e.g., uranium hexafluoride, amongst others) to increase desirable concentrations of ²³⁵U within the product stream of a used uranium-based fuel. Unfortunately, differences in isotropic mass within the working gas incidentally increase concentrations of light-weight, undesirable isotopes within the used nuclear fuel when exposed to a feed stream that is not composed of a naturally occurring essentially binary isotope vector (e.g., ²³⁵U and ²³⁸U). For the purposes herein, the term “complex” isotope vector shall be construed to include any isotope vector that includes three or more isotopes. In other words, a “complex” isotope vector is any isotope vector that is not binary. Such feed streams are always implicated when enriching used nuclear fuel, so the aforementioned problems are generally considered inescapable via known systems and methods.

Even used HEU—a premium fuel in which ²³⁵UF₆ has been enriched to near maximum levels—can include isotropic arrays with undesirable isotopes (e.g., ²³²UF₆, ²³⁴UF₆, and ²³⁶UF₆) that have masses as small as one Atomic Mass Unit (AMU) between isotopomers making differentiation of isotopes by mass difference enrichment methods essentially impossible. Accordingly, significant concentrations of ²³²UF₆ or ²³⁶UF₆ will find their way into the product stream, resulting in high radiation fields from ²³²U daughters that complicate subsequent fuel fabrication processing and high parasitic absorption from ²³⁶U requiring the additional cost of increased ²³⁵U enrichment. As such, there is a need for improved systems and methods for processing nuclear a material for use as a nuclear fuel. Specifically, there is a need for systems and methods that do not operate on mass difference-based means and therefore, are capable of enriching concentrations of desirable isotopes while controlling the concentration of undesirable isotopes.

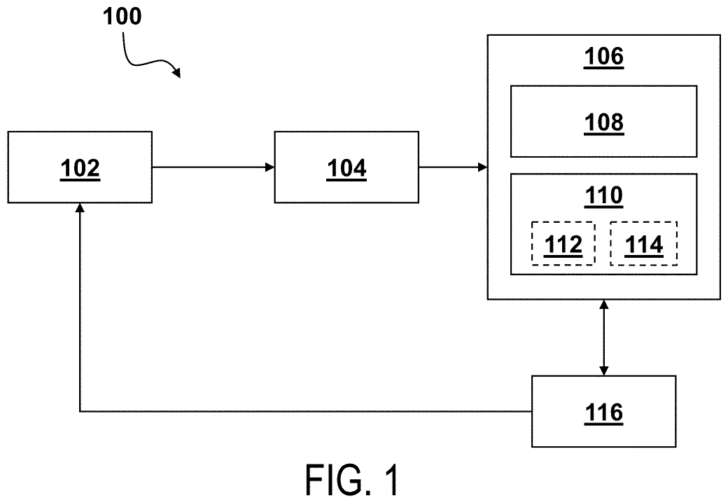

Referring now to FIG. 1, a diagram of a system 100 configured to process a nuclear material for use as a nuclear fuel in a nuclear reactor is depicted in accordance with at least one non-limiting aspect of the present disclosure. According to the non-limiting aspect of FIG. 1, the system 100 can include a control circuit 102, an emitter 104 configured to emit a beam of electromagnetic radiation, a chamber 106, a vaporizer 108, a nuclear material 110, and a sensor 116. The control circuit 102 can be communicably coupled to the emitter 104 and can be configured to receive instructions and control the emitter 104 in accordance with those received instructions. For example, the control circuit 102 can include any processor or logic-based controller. According to some non-limiting aspects, the control circuit 102 can be communicably coupled to an interface configured receive instructions in the form of a user input. However, according to other non-limiting aspects, the control circuit 102 can be communicably coupled to a memory in which instructions were stored. In this regard, the control circuit 102 can be flexibly configured to control the emitter 104 in accordance with real-time and/or predetermined instructions.

In further reference to FIG. 1, the system 100 can further include an emitter 104 configured to emit a beam of electromagnetic radiation. According to the non-limiting aspect of FIG. 1, the emitter 104 can be configured to emit beams of electromagnetic radiation including a desired range of wavelengths, such as wavelengths that are greater than or equal to 5 micrometers (μm) and less than or equal to 20 μm. Accordingly, the emitter 104 of FIG. 1 can be a laser. However, it shall be appreciated that the present disclosure contemplates other non-limiting aspects wherein the emitter can emit beams of electromagnetic radiation including any range of wavelengths. Additionally and/or alternatively, the emitter 104 of FIG. 1 can be tunable meaning, the wavelengths of beams of electromagnetic radiation it emits can be adjusted in accordance with instructions it receives from the control circuit 102. Notably, the emitter 104 can be configured to emit a beam of electromagnetic radiation that includes a desired wavelength configured to excite desirable isotopes, without exciting undesirable isotopes. As will be discussed, configuring the emitter 104 for a specific wavelength can facilitate targeted separation and enrichment. Furthermore, although the system of FIG. 1 depicts the emitter 104 external and separate from the chamber 106, it shall be appreciated that, according to other non-limiting aspects, the emitter 104 can be positioned within the chamber 106. Accordingly, the emitter 104 need only be positioned such that it can be communicably coupled to the control circuit 102 and can emit a beam of electromagnetic radiation at a nuclear material 110.

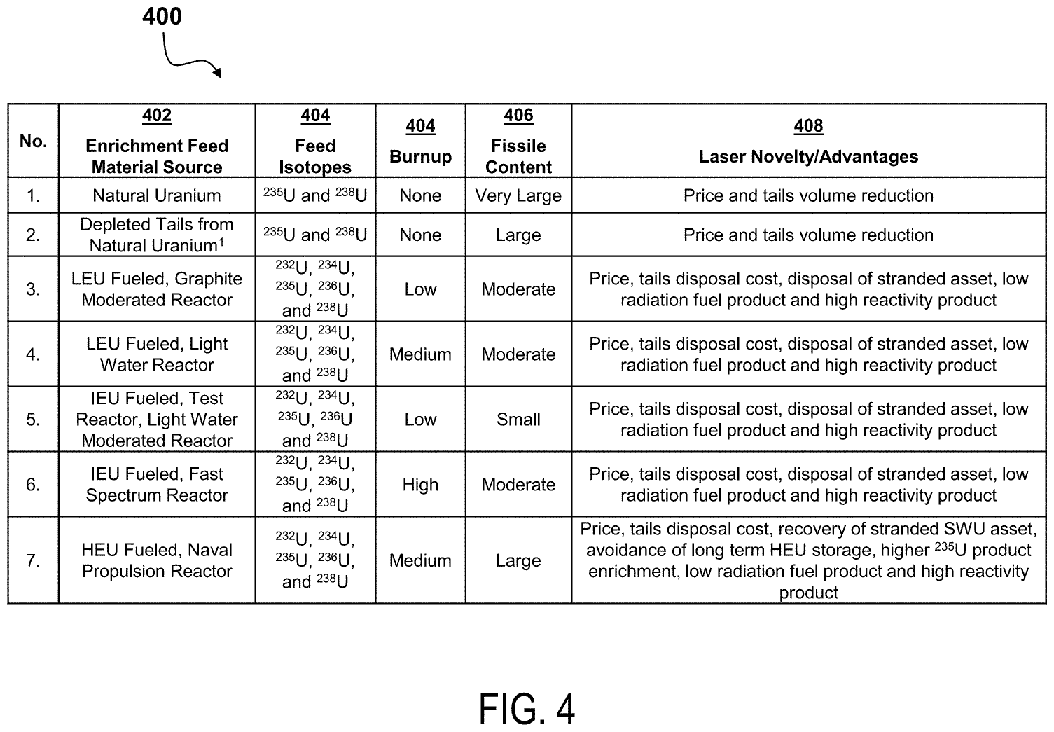

Still referring to FIG. 1, the system 100 can include a chamber 106 configured to contain a nuclear material 110 to be processed, as well as a vaporizer 108. As will be discussed in reference to FIG. 4, the nuclear material can include any used nuclear material that was previously used as a nuclear fuel. For example, the nuclear material 110 can include natural materials (e.g., uranium, plutonium, thorium), depleted tails from natural materials, LEU fuel from a graphite moderated reactor, LEU fuel from a LWR, IEU fuel from a test reactor and/or a moderated LWR, IEU fuel from a fast spectrum reactor, and/or HEU fuel from a naval propulsion reactor, amongst others. Accordingly, the nuclear material 110 need only include a complex isotope vector, as is typical of used nuclear fuel.

In further reference to FIG. 1, the system 100 can further include a vaporizer 108 that can be configured to fluorinate a feed stream of the nuclear material 110 to be enriched and separated by the emitter 104. According to the non-limiting aspect of FIG. 1, the vaporizer 108 can include any device capable of facilitating the transformation of the nuclear material 110 from a liquid or solid phase to a gaseous phase, thereby leaving a non-volatile residue behind. Additionally and/or alternatively, the vaporizer 108 can be configured to fluorinate depleted waste, such as the nuclear material 110 and/or any of its byproducts. According to some non-limiting aspects, the vaporizer 108 can be configured to produce a natural convection of the vaporized nuclear material 110, thereby eliminating the need for an additional pump to be included in the system 100. Regardless, the vaporizer 108 of FIG. 1 can filter the used nuclear material of fission products and actinides, thereby producing a purified feed stream (e.g., UF₆) that can be exposed to the beam of electromagnetic radiation for subsequent enrichment and separation.

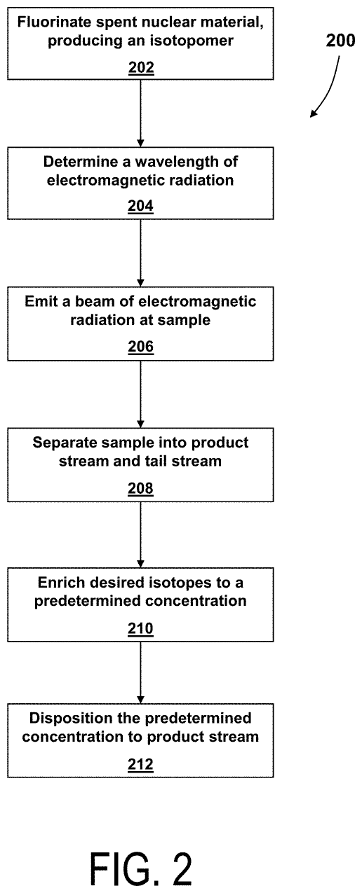

According to the non-limiting aspect of FIG. 1, the nuclear material 110 can be separated into a product stream 112 and a tail stream 114 after being exposed to a beam of electromagnetic radiation that includes the targeted wavelength. Because the emitter 104 can be configured to emit a beam of electromagnetic radiation that includes a desired wavelength, the feed stream of nuclear material 110 received from the vaporizer 108 and its isotopes and/or isotopomers can be selectively excited. In other words, the emitter 104 can be specifically configured to emit a beam of electromagnetic radiation that includes a particular wavelength that will excite desirable isotopes, without exciting undesirable isotopes. Thus, the desirable isotopes are separated into the product stream 112 while the undesirable isotopes are relegated to the tail stream 114 of the nuclear material 110. Accordingly, the product stream can be specifically configured to include desired isotopes in accordance with the method 200 of FIG. 2.

Still referring to FIG. 1, the system 100 can further include a sensor 116 configured to monitor characteristics of the chamber 106, the nuclear material 110, and/or the enrichment and separation processes as they are performed. The sensor can thus include any isotope identifier, radiation detector, and/or camera, amongst others, depending on user preference and/or intended application. Accordingly, the sensor 116 can be communicably connected to the chamber 106 and can gather information that subsequently sends to the control circuit 102. As such, the control circuit 102 can take any corrective measures necessary to ensure the product stream 112 and tail stream 114 are properly configured. For example, according to some non-limiting aspects, the sensor 116 can include a radiation detector. If the radiation detector 116 detects too strong of a radiation field generated by the product stream 112, the control circuit 102 may determine that the emitter 104 needs to be reconfigured to emit a beam of radiation that includes a different wavelength. In other words, the sensor 116 can help the control circuit 102 tune the emitter 104 to improve the resulting product stream 112, thereby further reducing the need for subsequent processing and/or manufacture.

Referring now to FIG. 2, a method 200 of processing a nuclear material for use as a nuclear fuel in a nuclear reactor is depicted in accordance with at least one non-limiting aspect of the present disclosure. For example, the method 200 of FIG. 2 can be employed to process a used nuclear fuel including, but not limited to, uranium or plutonium-based material, which exists as a residual byproduct of a material that was used as a nuclear fuel. As previously discussed, the nuclear material can include both desirable isotopes and undesirable isotopes.

As used herein, the term “undesirable” shall be construed to represent any isotope with characteristics that are adverse to the desired characteristics of the resulting nuclear fuel. For example, it may be desirable for a nuclear fuel to have one or more odd-numbered isotopes (e.g. ²³⁵U) and undesirable for a nuclear fuel to have one or more even-numbered isotopes (e.g. ²³²U, ²³⁴U, ²³⁶U, ²³⁸U), depending on user preference or intended application. Even-numbered isotopes can be very costly to process out of the enriched feedstock and thus, it is preferable to never allow them into the product stream. For example, ²³²U can be a radiological hazard because of its decay daughter ²⁰⁸TI, which causes extraordinarily high gamma radiation that requires remote fabrication when ²³²U is above concentrations measured in parts per billion (ppb). Likewise, ²³⁴U can provide a significant source of radiation exposure during post-enrichment fabrication and can result in additional exposure due to its high α-particle activity. Finally, ²³⁶U can exist in large quantities due to failed fission reactions of ²³⁵U (e.g., ²³⁶U can ˜20% the rate of ²³⁵U fission) and has significant parasitic absorption when irradiated. Accordingly, the method 200 of FIG. 2 can be used to direct undesirable isotopes, such as ²³²U, ²³⁴U, and/or ²³⁶U, to the tails stream of the resulting product essentially isolating the desirable isotopes, such as ²³⁵U in the product stream. As such, the method 200 can be used to enhance the product stream for re-use as a nuclear fuel.

It shall be appreciated that the foregoing nuclear materials and isotopes are presented solely for illustrative purposes. Accordingly, the method 200 of FIG. 2 can be employed to process any nuclear materials that have a composition of both desirable and undesirable isotopes.

Accordingly, a technician can employ method 200 to enrich desirable isotopes of a used nuclear material while relegating undesirable isotopes of the nuclear material to a tail stream of the resulting byproduct. The method 200 can include fluorinating the used nuclear material 202, as is typically required of most conventional methods. As such, any known methods and/or means of fluorinating a depleted waste product can be implemented to fluorinate used material 202, preferably after the used nuclear material has been filtered from fission products and actinides by a preliminary means of pre-processing. For example, fluorination can be accomplished via the following chemical reactions:

UO₂+4HF→UF₄+2H₂O

UF₄+F₂→UF₆

Additionally and/or alternatively, the fluorination step 202 can include the following chemical reaction:

Uₘₑₜₐₗ+2CIF₃→UF₆+Cl₂

In other words, the fluorination step 202 can result in a purified stream for enrichment (e.g., UF₆) that includes a desirable isotopomer (e.g., ²³⁵UF ₆), to be targeted for subsequent separation 208, enrichment 210, and dispositioning 212. It should be noted that the aforementioned vaporizer 108 of FIG. 1 can be used to perform the fluorination step 202 of FIG. 2. Although many known methods and/or means of processing used nuclear materials include the fluorination of depleted waste products, it shall be appreciated that the fluorination step is not always required in order to achieve the benefits disclosed herein. As such, according to some non-limiting aspects, the method 200 excludes the fluorination step 202 and is thus implemented on used nuclear materials that have not been fluorinated.

According to the non-limiting aspect of FIG. 2, the method 200 can further include determining a wavelength of electromagnetic radiation 204. The determination step 204 can be based, at least in part, on the identification of a desired isotope and/or isotopomer. For example, the wavelength can be determined to specifically target an odd-numbered isotopomer (e.g., ²³⁵UF ₆) from the isotopic vector of the used nuclear material. Isotopes are virtually identical for the purpose of separation with the exception of their respective wavelengths of atomic transitions, otherwise known as the “isotope shift”. At step 204, the method 200 takes advantage of this shift such that the particular wavelength is determined to target and excite a selection of isotopes from the complex isotope vector of the used nuclear material, while the others remain unaffected. In other words, step 204 can be implemented to specifically tune an emitter 104 (FIG. 1), such as a laser, such that it can target, excite, and separate desired isotopes from the used nuclear material. Of course, other factors can be considered when determining the wavelength, including the initial enrichment of desired isotopes, fuel irradiation time, and/or neutron flux level and energy spectrum.

Still referring to FIG. 2, after fluorination 202 and the determination of the wavelength 204, the nuclear material can be presented as a feed stream to be irradiated by an emitter 104 (FIG. 1), such as a laser. The method 200 of FIG. 2 then calls for an emission of a beam of electromagnetic radiation 206 that includes the wavelength determined at step 204. Because the emission 206 includes a wavelength determined 204 based, at least in part, on a desired isotope of the used nuclear material, the emission can cause the subsequent excitation of the targeted isotope. However, unlike conventional means of processing used nuclear materials, the rest of the complex isotope vector remains unexcited. Accordingly, the method 200 of FIG. 2 can further include the separating 208 of the nuclear material into a tail stream and a product stream, which can result from the ensuing excitation caused by the emission of electromagnetic radiation 206.

When exposed to the determined wavelength, desirable isotopes can begin to enrich 210—that is, increase in concentration—to a degree that is predetermined based on user preference and/or intended application. In other words, the concentration can be predetermined such that the processed nuclear material will produce a specific fission reaction when it is re-implemented as a nuclear fuel in a nuclear reactor. According to some non-limiting aspects, the laser-based enrichment process can target, and result from, the excitation of an isotopomer (e.g., ²³⁵UF₆) of the feed stream (e.g., UF₆). Finally, the excitation of the desired isotope can cause the disposition of the predetermined concentration of the desired isotope into the product stream 212, relegating undesirable isotopes of the complex isotope vector to the tail stream. Thus, the method 200 of FIG. 2 can produce a discrete product stream that is separate from a discrete tail stream that is independent of the mass of the targeted isotope and the masses of the other isotopes in the isotope vector, wherein the product stream includes a predetermined concentration of an enriched, desirable isotope for reuse, and the tail stream includes unenriched—if not diminished—concentrations of undesirable isotopes of the complex isotope vector. In other words, the method 200 of FIG. 2 can produce a product stream that can be efficiently manufactured into a recycled nuclear fuel, exonerated from the expensive and inefficient post-processing procedures required of conventional methods and systems.

It shall be appreciated that the method 200 of FIG. 2 can include innumerable benefits. For example, exposure to the emitted beam can enrich the desired isotopes to a predetermined concentration. Additionally, exposure to the emitted beam can scrub—or, reduce the concentration of—undesired isotopes from the used nuclear material. This scrubbing can be beneficial because undesirable isotopes—such as ²³²U and thereby its daughter product ²⁰⁸TI—which has a multiplicity of high energy gammas (e.g., 2.5 million electron-volts or MeV), which results in an intense radiation or that is parasitic to irradiation and thus, can require increased concentrations of desirable isotopes—such as ²³⁵U—to compensate for the parasitic absorption. Parasitic absorption can further result in additional long-lived residual isotopes (e.g., ²³⁷Np) in the used fuel waste stream. Thus, reducing concentrations of undesirable isotopes alone can be beneficial to the resulting product stream—let alone the simultaneous reduction of concentrations of undesirable isotopes and increase in concentrations of desirable isotopes, as provided by the method 200 of FIG. 2. As such, the method 200 of FIG. 2 can ultimately, require less enrichment than conventional means of enriching used nuclear materials to produce the same amount of core reactive fuel.

Additionally and/or alternatively, it shall be appreciated that the method 200 of FIG. 2 can be implemented to process any used nuclear materials, including those that are highly-enriched. The method 200 can be material agnostic, assuming the used nuclear material includes a complex isotope vector, wherein the isotopes of the vector possess a sufficient isotope shift. For example, HEU-based materials are typically used as expensive fuels for military applications, such as naval reactors. Such materials are expensive to process into HEU, which possesses a considerable separative work unit (SWU) value. However, since naval reactors discharge used HEU-based materials that possess complex isotope vectors that can be fluorinated, the method 200 of FIG. 2 can be employed to reprocess and separate the HEU-assays to achieve the desired concentrations of odd-numbered isotopes while isolating and/or reducing concentrations of even-numbered concentrations, effectively scrubbing these troublesome isotopes from the product stream. As such, the method 200 of FIG. 2 can be used to reprocess used naval reactor fuel while optimizing residual SWU value.

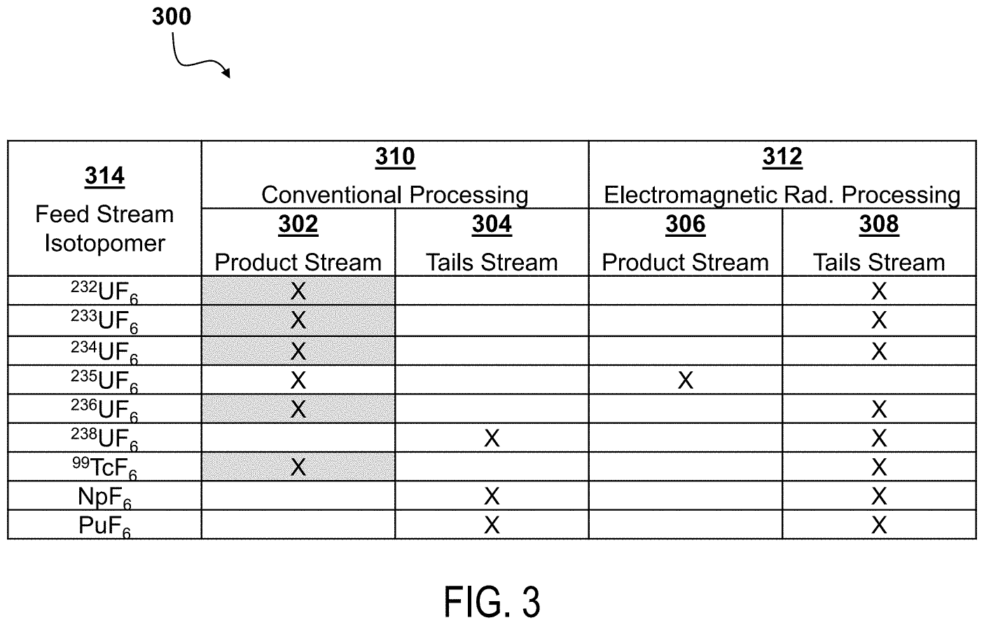

Referring now to FIG. 3, a table 300 contrasting the contents of a product stream 302 and a tail stream 304 of a nuclear material processed via conventional methods 310 against the contents of a product stream 306 and a tail stream 308 of nuclear material processed via the systems 100 (FIG. 1) and methods 200 (FIG. 2) disclosed herein, is depicted in accordance with at least one non-limiting aspect of the present disclosure. Specifically, the table 300 shows how many isotopes of a complex isotope vector 314 are allowed to enter the product stream 302 via conventional methods and systems 310. This is because conventional methods and systems 310 rely on the mass differential of isotopes, which cannot effectively discriminate between desirable and undesirable isotopes of the vector 314. According to the non-limiting aspect of FIG. 3, the only isotope of the vector that is desired in the product stream 302 is 235UF₆. However, the product stream 302 produced via conventional methods 310 possesses numerous undesirable isotopes, including ²³²UF₆, ²³³UF₆, ²³⁴UF₆, ²³⁶UF₆, and ⁹⁹TcF₆, all of which are highlighted to illustrate the percent composition of the conventional product stream 302 that is undesirable. Contrarily, according to the non-limiting aspect of FIG. 3, the product stream 306 produced via the systems 100 (FIG. 1) and methods 200 (FIG. 2) disclosed herein can exclusively possess the desirable isotopes, in this case ²³⁵UF₆. As such, the table 300 of FIG. 3 illustrates how the systems 100 (FIG. 1) and methods 200 (FIG. 2) disclosed herein can be implemented to preferentially separate a complex isotope vector 314, in a way that conventional processing 310 was previously incapable.

Referring now to FIG. 4, a table 400 listing some of the benefits 408 of processing various nuclear materials 402 via the systems 100 (FIG. 1) and methods 200 (FIG. 2) disclosed herein is depicted in accordance with at least one non-limiting aspect of the present disclosure. According to the non-limiting aspect of FIG. 4, each nuclear material 402 can include various characteristics 404, 404, 406, including different isotopes 404 in its complex isotope vector, different degrees of burnup 404, and different fissile contents 406. Nonetheless, the systems 100 (FIG. 1) and methods 200 (FIG. 2) disclosed herein can be employed to provide innumerable benefits, only some 408 of which are depicted in the table 400 of FIG. 4. Notably, the systems 100 (FIG. 1) and methods 200 (FIG. 2) disclosed herein provide economic benefits to the processing of any of the nuclear materials 402. It shall be appreciated that the table 400 of FIG. 4 is not intended to be exclusive, meaning, the systems 100 (FIG. 1) and methods 200 (FIG. 2) disclosed herein can be implemented to process any number of other nuclear materials depending on user preference and/or intended application.

It shall be appreciated that the methods and systems disclosed herein can be used to isolate desired isotopes of a complex isotope vector from undesired isotopes of the complex isotope vector. For example, according to some non-limiting aspects, undesired isotopes can be dispositioned to a tails stream of the nuclear material. According to other non-limiting aspects, desired isotopes can be dispositioned to a product stream of the nuclear material. Accordingly, the term “targeted isotope”, as used herein, shall be construed to include any isotope—desired or undesired—that a user hopes to excite via electromagnetic radiation and disposition to either a product stream or tails stream of the nuclear material. Likewise, the methods and systems disclosed herein can be used to excite and disposition any targeted isotope to any desired stream—product or tails—of the nuclear material. Finally, the non-limiting aspects disclosed herein are merely intended to be illustrative. Accordingly, the present disclosure contemplates numerous aspects in which both even-numbered and odd-numbered isotopes can be desired and thus, targeted. As long as a wavelength is specifically chosen to target, excite, and disposition and isotope of a nuclear material, the methods and systems disclosed herein can be employed.

Various aspects of the subject matter described herein are set out in the following numbered clauses:

Clause 1: A method of processing a nuclear material for use as a nuclear fuel in a nuclear reactor, wherein the nuclear material includes a complex isotope vector including a plurality of isotopes, wherein the plurality of isotopes includes a targeted isotope and a non-targeted isotope, the method including: determining a wavelength of electromagnetic radiation based, at least in part, on the targeted isotope; emitting a beam of electromagnetic radiation including the determined wavelength towards the nuclear material; separating, via the emitted beam of electromagnetic radiation, the nuclear material into a first stream and a second stream; enriching, via the emitted beam of electromagnetic radiation, a concentration of the targeted isotope to a predetermined concentration; and dispositioning, via a sensitivity to the determined wavelength, the enriched concentration of the targeted isotope to the first stream of the nuclear material; and dispositioning, via a lack of sensitivity to the determined wavelength, the non-targeted isotope to the second stream of the nuclear material.

Clause 2: The method according to clause 1, wherein the first stream is a product stream of the nuclear material, and wherein the second stream is a tails stream of the nuclear material.

Clause 3: The method according to clauses 1 or 2, further including fluorinating the targeted isotope, thereby producing an isotopomer, and wherein enriching the concentration of the targeted isotope to a predetermined concentration includes exciting, via the determined wavelength, the produced isotopomer.

Clause 4: The method according to any of clauses 1-3, further including: determining a desired magnitude of a radiation field of the nuclear fuel; and dispositioning, via the emitted beam of electromagnetic radiation, the non-targeted isotope to the second stream of the nuclear material based, at least in part, on the desired magnitude of the radiation field of the nuclear fuel.

Clause 5: The method according to any of clauses 1-4, further including determining an amount of parasitic absorption associated with the non-targeted isotope, and wherein enriching the concentration of the targeted isotope to a predetermined concentration is based, at least in part, on the determined amount of parasitic absorption.

Clause 6: The method according to any of clauses 1-5, wherein the nuclear material includes a used nuclear fuel.

Clause 7: The method according to any of clauses 1-6, wherein the used nuclear fuel includes thorium.

Clause 8. The method according to any of clauses 1-7, wherein the targeted isotope includes ²³³U.

Clause 9: The method according to any of clauses 1-8, wherein the used nuclear fuel includes a minor actinide.

Clause 10: The method according to any of clauses 1-9, wherein the used nuclear fuel includes plutonium.

Clause 11: The method according to any of clauses 1-10, wherein the targeted isotope includes at least one of ²³⁹PU and ²⁴¹Pu.

Clause 12: The method according to any of clauses 1-11, wherein the used nuclear fuel includes uranium.

Clause 13: The method according to any of clauses 1-12, wherein the non-targeted isotope is one of a plurality of non-targeted isotopes, wherein the plurality of non-targeted isotopes is a subset of the plurality of isotopes, and wherein the plurality of non-targeted isotopes includes at least one of ²³²U, ²³⁴U, ²³⁶U, and ²³⁸U, or combinations thereof.

Clause 14: The method according to any of clauses 1-13, wherein the targeted isotope includes ²³⁵U.

Clause 15: A system configured to process a nuclear material for use as a nuclear fuel in a nuclear reactor, wherein the nuclear material includes a complex isotope vector including a targeted isotope and a non-targeted isotope, the system including: an emitter configured to emit a beam of electromagnetic radiation at the nuclear material; and a control circuit configured in signal communication with the emitter, wherein the control circuit is configured to: receive an input including a wavelength of electromagnetic radiation, wherein the wavelength is determined based, at least in part, on the targeted isotope; and cause the emitter to emit a beam including the wavelength of electromagnetic radiation towards the nuclear material; wherein the wavelength of electromagnetic radiation, upon interacting with the nuclear material, is configured to: separate the nuclear material into a first stream and a second stream; enrich a concentration of the targeted isotope to a predetermined concentration; disposition, via a sensitivity to the wavelength of electromagnetic radiation, the enriched concentration of the targeted isotope to the first stream of the nuclear material; and disposition, via a lack of sensitivity to the wavelength of electromagnetic radiation, the non-targeted isotope to the second stream of the nuclear material.

Clause 16: The system according to clause 15, wherein the emitter is further configured to fluorinate the targeted isotope, thereby producing an isotopomer, and wherein the wavelength of electromagnetic radiation is configured to enrich the concentration of the targeted isotope to a predetermined concentration by exciting the produced isotopomer.

Clause 17: The system according to clauses 15 or 16, wherein the control circuit is further configured to receive an input including a determined amount of parasitic absorption associated with the non-targeted isotope, and wherein the wavelength of electromagnetic radiation is configured to enrich the concentration of the targeted isotope to a predetermined concentration based, at least in part, on the determined amount of parasitic absorption.

Clause 18: The system according to any of clauses 15-17, wherein the nuclear material includes a used nuclear fuel.

Clause 19: A method of processing a nuclear material for use as a nuclear fuel in a nuclear reactor, wherein the nuclear material includes a complex isotope vector including a plurality of isotopes, wherein the plurality of isotopes includes a targeted isotope and a non-targeted isotope, the method including: emitting a beam of electromagnetic radiation including a wavelength towards the nuclear material; enriching, via the beam of electromagnetic radiation, a concentration of the targeted isotope to a predetermined concentration; dispositioning, via a sensitivity to the wavelength, the enriched concentration of the targeted isotope to a first stream of the nuclear material; and dispositioning, via a lack of sensitivity to the wavelength, the non-targeted isotope to a second stream of the nuclear material.

Clause 20: The method according to clause 19, further including fluorinating the targeted isotope, thereby producing an isotopomer, and wherein enriching the concentration of the targeted isotope to a predetermined concentration includes exciting, via the emitted beam of electromagnetic radiation, the produced isotopomer.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A method of processing a nuclear material for use as a nuclear fuel in a nuclear reactor, wherein the nuclear material comprises a complex isotope vector comprising a plurality of isotopes, wherein the plurality of isotopes comprises a targeted isotope and a non-targeted isotope, the method comprising:
determining a wavelength of electromagnetic radiation based, at least in part, on the targeted isotope;
emitting a beam of electromagnetic radiation comprising the determined wavelength towards the nuclear material;
separating, via the emitted beam of electromagnetic radiation, the nuclear material into a first stream and a second stream;
enriching, via the emitted beam of electromagnetic radiation, a concentration of the targeted isotope to a predetermined concentration;
dispositioning, via a sensitivity to the determined wavelength, the enriched concentration of the targeted isotope to the first stream of the nuclear material; and
dispositioning, via a lack of sensitivity to the determined wavelength, the non-targeted isotope to the second stream of the nuclear material.

2. The method of claim 1, wherein the first stream is a product stream of the nuclear material, and wherein the second stream is a tails stream of the nuclear material.

3. The method of claim 1, further comprising fluorinating the targeted isotope, thereby producing an isotopomer, and wherein enriching the concentration of the targeted isotope to a predetermined concentration comprises exciting, via the determined wavelength, the produced isotopomer.

4. The method of claim 1, further comprising:
determining a desired magnitude of a radiation field of the nuclear fuel; and
dispositioning, via the emitted beam of electromagnetic radiation, the non-targeted isotope to the second stream of the nuclear material based, at least in part, on the desired magnitude of the radiation field of the nuclear fuel.

5. The method of claim 1, further comprising determining an amount of parasitic absorption associated with the non-targeted isotope, and wherein enriching the concentration of the targeted isotope to a predetermined concentration is based, at least in part, on the determined amount of parasitic absorption.

6. The method of claim 1, wherein the nuclear material comprises a used nuclear fuel.

7. The method of claim 6, wherein the used nuclear fuel comprises thorium.

8. The method of claim 7, wherein the targeted isotope comprises ²³³U.

9. The method of claim 6, wherein the used nuclear fuel comprises a minor actinide.

10. The method of claim 6, wherein the used nuclear fuel comprises plutonium.

11. The method of claim 10, wherein the targeted isotope comprises at least one of ²³⁹PU and ²⁴¹Pu.

12. The method of claim 6, wherein the used nuclear fuel comprises uranium.

13. The method of claim 12, wherein the non-targeted isotope is one of a plurality of non-targeted isotopes, wherein the plurality of non-targeted isotopes is a subset of the plurality of isotopes, and wherein the plurality of non-targeted isotopes comprises at least one of 232U, ²³⁴U, ²³⁶U, and ²³⁸U, or combinations thereof.

14. The method of claim 12, wherein the targeted isotope comprises 235U.

15. A system configured to process a nuclear material for use as a nuclear fuel in a nuclear reactor, wherein the nuclear material comprises a complex isotope vector comprising a targeted isotope and a non-targeted isotope, the system comprising:
an emitter configured to emit a beam of electromagnetic radiation at the nuclear material; and
a control circuit configured in signal communication with the emitter, wherein the control circuit is configured to:
receive an input comprising a wavelength of electromagnetic radiation, wherein the wavelength is determined based, at least in part, on the targeted isotope; and
cause the emitter to emit a beam comprising the wavelength of electromagnetic radiation towards the nuclear material;
wherein the wavelength of electromagnetic radiation, upon interacting with the nuclear material, is configured to:
separate the nuclear material into a first stream and a second stream;
enrich a concentration of the targeted isotope to a predetermined concentration;
disposition, via a sensitivity to the wavelength of electromagnetic radiation, the enriched concentration of the targeted isotope to the first stream of the nuclear material; and
disposition, via a lack of sensitivity to the wavelength of electromagnetic radiation, the non-targeted isotope to the second stream of the nuclear material.

16. The system of claim 15, wherein the emitter is further configured to fluorinate the targeted isotope, thereby producing an isotopomer, and wherein the wavelength of electromagnetic radiation is configured to enrich the concentration of the targeted isotope to a predetermined concentration by exciting the produced isotopomer.

17. The system of claim 15, wherein the control circuit is further configured to receive an input comprising a determined amount of parasitic absorption associated with the non-targeted isotope, and wherein the wavelength of electromagnetic radiation is configured to enrich the concentration of the targeted isotope to a predetermined concentration based, at least in part, on the determined amount of parasitic absorption.

18. The method of claim 15, wherein the nuclear material comprises a used nuclear fuel.

19. A method of processing a nuclear material for use as a nuclear fuel in a nuclear reactor, wherein the nuclear material comprises a complex isotope vector comprising a plurality of isotopes, wherein the plurality of isotopes comprises a targeted isotope and a non-targeted isotope, the method comprising:
emitting a beam of electromagnetic radiation comprising a wavelength towards the nuclear material;
enriching, via the beam of electromagnetic radiation, a concentration of the targeted isotope to a predetermined concentration;
dispositioning, via a sensitivity to the wavelength, the enriched concentration of the targeted isotope to a first stream of the nuclear material; and
dispositioning, via a lack of sensitivity to the wavelength, the non-targeted isotope to a second stream of the nuclear material.

20. The method of claim 19, further comprising fluorinating the targeted isotope, thereby producing an isotopomer, and wherein enriching the concentration of the targeted isotope to a predetermined concentration comprises exciting, via the emitted beam of electromagnetic radiation, the produced isotopomer.
